(19) United States
(12) Patent Application Publication
(10) Pub. No.: US 2010/0321199 A1
(43) Pub. Date: Dec. 23, 2010

(54) Light-emitting module and image-capturing module for arbitrarily changing light-emitting position

(76) Inventors: Chi-Hsing Hsu, Taipei (TW); Chun-Yu Lu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,606

(22) Filed: Jun. 17, 2009

(51) Int. Cl. G08B 5/00; F21V 8/00; G01J 1/20

(52) U.S. Cl. 340/815.42; 362/555; 250/201.1

(57) ABSTRACT

A light-emitting module for arbitrarily changing light-emitting position includes a PCB unit, a light-emitting unit, an outer shell unit and a light-guiding unit. The light-emitting unit has at least one light-emitting element electrically disposed on the PCB unit. The outer shell unit is disposed above the PCB unit and the light-emitting unit, and the outer shell unit has at least one opening. The light-guiding unit is close to the at least one light-emitting element. One partial area of the light-guiding unit is exposed by the at least one opening, so that light beams generated by the at least one light-emitting element are guided by the light-guiding unit and are projected out from the at least one opening.

### BACKGROUND OF THE INVENTION

1. Field of the Invention

The present invention relates to a light-emitting module and an image-capturing module, in particular, to a light-emitting module and an image-capturing module for arbitrarily changing light-emitting position.

2. Description of Related Art

A computer system is composed of hardware and software. The hardware typically includes a motherboard, an optical disk drive, a hard disk drive, a memory, a network card, and so on. When the computer system is running, it is necessary to know working states of the hardware. Thus, indicator lamps are used to show the working states of the hardware, and corresponding drive circuits for driving these indicator lamps are combined in the computer system. In addition, an indicator lamp can be applied to an image-capturing module in order to monitor the usage state of the image-capturing module. Most indicator lamps are designed as light emitting diodes (LEDs).

However, the LEDs require an opening of an outer shell in order to be seen by the user, and the position of the opening must match the position of the LED on the computer body or the body of the image capturing module. Thus, different outer shells need to be designed to accommodate different positions of the LEDs on different computer models or image capturing models, even if the different models have the same outer shape. This inevitably leads to increased manufacturing costs for the final product.

### SUMMARY OF THE INVENTION

In view of the aforementioned issues, the present invention provides a light-emitting module and an image-capturing module for arbitrarily changing light-emitting position. The present invention can achieve signal indication effect without changing the position of the light-emitting element and the position of the opening of outer shell.

To achieve the above-mentioned objectives, the present invention provides a light-emitting module for arbitrarily changing light-emitting position, including: a PCB unit, a light-emitting unit, an outer shell unit and a light-guiding unit. The light-emitting unit has at least one light-emitting element electrically disposed on the PCB unit. The outer shell unit is disposed above the PCB unit and the light-emitting unit, and the outer shell unit has at least one opening. The light-guiding unit is close to the at least one light-emitting element. One partial area of the light-guiding unit is exposed by the at least one opening, so that light beams generated by the at least one light-emitting element are guided by the light-guiding unit and are projected out from the at least one opening.

To achieve the above-mentioned objectives, the present invention provides an image-capturing module for arbitrarily changing light-emitting position, including: a PCB unit, an image-capturing unit, a light-emitting unit, an outer shell unit and a light-guiding unit. The image-capturing unit is electrically disposed on the PCB unit. The light-emitting unit is disposed beside the image-capturing unit, and the light-emitting unit has at least one light-emitting element electrically disposed on the PCB unit. The outer shell unit is disposed above the PCB unit and the light-emitting unit, and the outer shell unit has at least one first opening for exposing the image-capturing unit and at least one second opening beside the at least one first opening. The light-guiding unit is close to the at least one light-emitting element. One partial area of the light-guiding unit is exposed by the at least one second opening, so that light beams generated by the at least one light-emitting element are guided by the light-guiding unit and are projected out from the at least one second opening.

Therefore, the light-guiding unit is mated with the opening of the outer shell unit, so that the present invention can achieve signal indication effect without changing the position of the light-emitting element and the position of the opening of outer shell unit. In other words, the light-emitting position can be arbitrarily changed according to the design position of the opening of the outer shell unit.

In order to further understand the techniques, means and effects the present invention takes for achieving the prescribed objectives, the following detailed descriptions and append portioned drawings are hereby referred, such that, through which, the purposes, features and aspects of the present invention can be thoroughly and concretely appreciated; however, the append portioned drawings are merely provided for reference and illustration, without any intention to be used for limiting the present invention.

### BRIEF DESCRIPTION OF THE DRAWINGS

FIG. 1A is a lateral, cross-sectional, schematic view of the light-emitting module for arbitrarily changing light-emitting position according to the first embodiment of the present invention;

FIG. 1B is a top, schematic view of the light-emitting module for arbitrarily changing light-emitting position according to the first embodiment of the present invention;

FIG. 2A is a lateral, cross-sectional, schematic view of the light-emitting module for arbitrarily changing light-emitting position according to the second embodiment of the present invention;

FIG. 2B is a top, schematic view of the light-emitting module for arbitrarily changing light-emitting position according to the second embodiment of the present invention;

FIG. 3A is a lateral, cross-sectional, schematic view of the light-emitting module for arbitrarily changing light-emitting position according to the third embodiment of the present invention;

FIG. 3B is a top, schematic view of the light-emitting module for arbitrarily changing light-emitting position according to the third embodiment of the present invention;

FIG. 4A is a lateral, cross-sectional, schematic view of the image-capturing module for arbitrarily changing light-emitting position according to the fourth embodiment of the present invention;

FIG. 4B is a top, schematic view of the image-capturing module for arbitrarily changing light-emitting position according to the fourth embodiment of the present invention;

FIG. 5A is a lateral, cross-sectional, schematic view of the image-capturing module for arbitrarily changing light-emitting position according to the fifth embodiment of the present invention;

FIG. 5B is a top, schematic view of the image-capturing module for arbitrarily changing light-emitting position according to the fifth embodiment of the present invention;

FIG. 6A is a lateral, cross-sectional, schematic view of the image-capturing module for arbitrarily changing light-emitting position according to the sixth embodiment of the present invention; and

FIG. 6B is a top, schematic view of the image-capturing module for arbitrarily changing light-emitting position according to the sixth embodiment of the present invention.

### DETAILED DESCRIPTION OF THE PREFERRED EMBODIMENTS

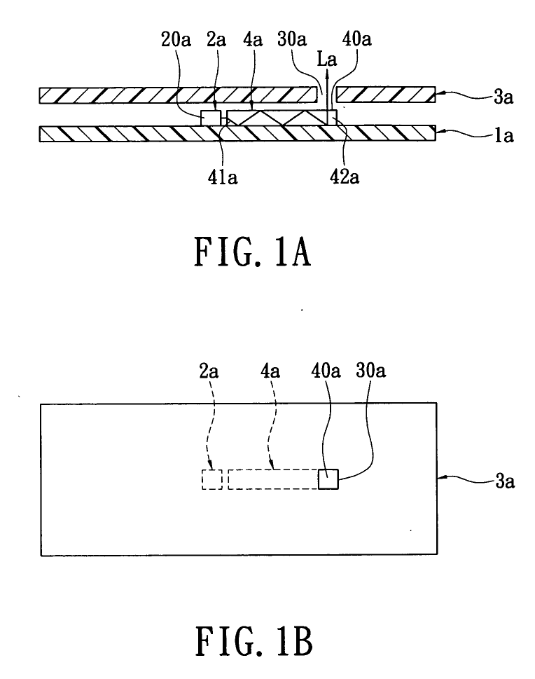

Referring to FIGS. 1A and 1B, the first embodiment of the present invention provides a light-emitting module for arbitrarily changing light-emitting position, including: a PCB (Printed Circuit Board) unit 1a, a light-emitting unit 2a, an outer shell unit 3a and a light-guiding unit 4a.

Moreover, the light-emitting unit 2a has at least one light-emitting element 20a electrically disposed on the PCB unit 1a, and the light-emitting element 20a can be an LED (Light Emitting Diode) or any element that can generate light. For example, if the light-emitting unit 2a is applied to indicate power, the light-emitting element 20a can be a signal indicator lamp for indicating usage state of power.

Furthermore, the outer shell unit 3a is disposed above the PCB unit 1a and the light-emitting unit 2a, and the outer shell unit 3a has at least one opening 30a. For example, the outer shell unit 3a can be a faceplate.

In addition, the light-guiding unit 4a is close to the at least one light-emitting element 20a. One partial area 40a of the light-guiding unit 4a is exposed by the at least one opening 30a, so that light beams La generated by the at least one light-emitting element 20a are guided by the light-guiding unit 4a and are projected out from the at least one opening 30a. For example, in the first embodiment, one end portion 41a of the light-guiding unit 4a is close to the light-emitting element 20a, and other end portion 42a of the light-guiding unit 4a is close to the opening 30a and is exposed by the opening 30a.

Moreover, the light-guiding unit 4a can be a light guide film, a light guide post, a light guide pipe, a light guide plate, a light guide ink, optic fibers, a prism or any element that can guide light beams to move or change position according to different requirement. In addition, the light-guiding unit 4a can be a plastic plate or a glass plate according to different material design.

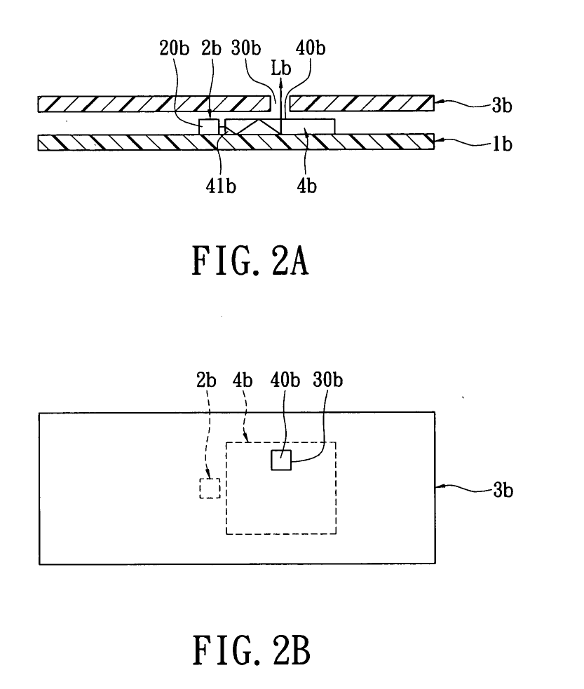

Referring to FIGS. 2A and 2B, the second embodiment of the present invention provides a light-emitting module for arbitrarily changing light-emitting position, including: a PCB unit 1b, a light-emitting unit 2b, an outer shell unit 3b and a light-guiding unit 4b. The difference between the second embodiment and the first embodiment is that: in the second embodiment, one partial area of one end portion 41b of the light-guiding unit 4b is close to the light-emitting element 20b, and one partial area 40b of a top surface of the light-guiding unit 4b is exposed by the opening 30b. Hence, light beams Lb generated by the at least one light-emitting element 20b are guided by the light-guiding unit 4b and are projected out from the at least one opening 30b.

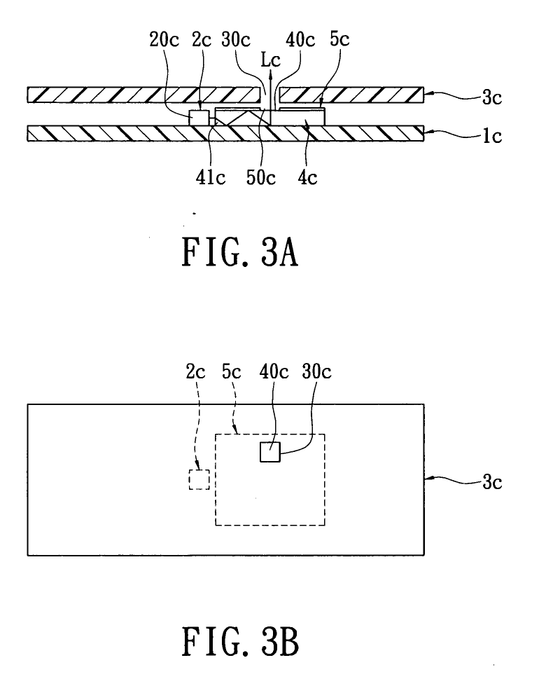

Referring to FIGS. 3A and 3B, the third embodiment of the present invention provides a light-emitting module for arbitrarily changing light-emitting position, including: a PCB unit 1c, a light-emitting unit 2c, an outer shell unit 3c and a light-guiding unit 4c. The difference between the third embodiment and the first and the second embodiments is that: in the third embodiment, the light-guiding unit 4c has a shading layer 5c disposed on a top surface thereof, and the shading layer 5c has at least one light-exiting hole 50c corresponding to the at least one opening 30c. In addition, one partial area of one end portion 41c of the light-guiding unit 4c is close to the light-emitting element 20c, and one partial area 40c of a top surface of the light-guiding unit 4c is exposed by the opening 30c and the light-exiting hole 50c. Hence, light beams Lc generated by the at least one light-emitting element 20c are guided by the light-guiding unit 4c and are projected out from the light-exiting hole 50c and the at least one opening 30c.

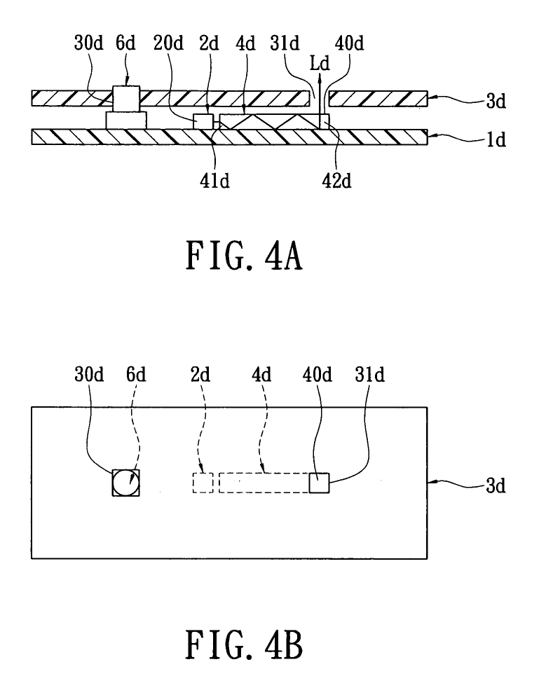

Referring to FIGS. 4A and 4B, the fourth embodiment of the present invention provides an image-capturing module for arbitrarily changing light-emitting position, including: a PCB unit 1d, a light-emitting unit 2d, an outer shell unit 3d, a light-guiding unit 4d and an image-capturing unit 6d.

The image-capturing unit 6d is electrically disposed on the PCB unit 1d. The light-emitting unit 2d is disposed beside the image-capturing unit 6d, and the light-emitting unit 2d has at least one light-emitting element 20d electrically disposed on the PCB unit 1d in order to indicate the usage state of the image-capturing unit 6d. In addition, the outer shell unit 3d is disposed above the PCB unit 1d and the light-emitting unit 2d, and the outer shell unit 3d has at least one first opening 30d for exposing the image-capturing unit 6d and at least one second opening 31d beside the at least one first opening 30d.

Moreover, the light-guiding unit 4d is close to the at least one light-emitting element 20d. One partial area 40d of the light-guiding unit 4d is exposed by the at least one second opening 31d, so that light beams Ld generated by the at least one light-emitting element 20d are guided by the light-guiding unit 4d and are projected out from the at least one second opening 31d. In the fourth embodiment, one end portion 41d of the light-guiding unit 4d is close to the light-emitting element 20d, and other end portion 42d of the light-guiding unit 4d is close to the second opening 31d and is exposed by the second opening 31d.

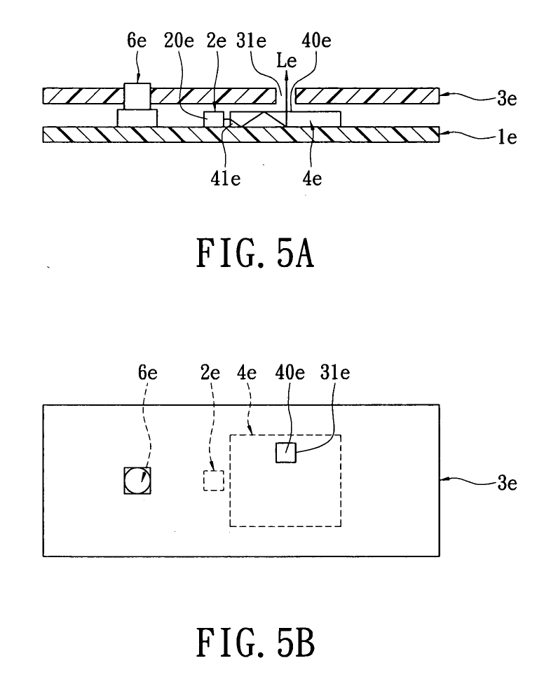

Referring to FIGS. 5A and 5B, the fifth embodiment of the present invention provides an image-capturing module for arbitrarily changing light-emitting position, including: a PCB unit 1e, a light-emitting unit 2e, an outer shell unit 3e, a light-guiding unit 4e and an image-capturing unit 6e. The difference between the fifth embodiment and the fourth embodiment is that: in the fifth embodiment, one partial area of one end portion 41e of the light-guiding unit 4e is close to the light-emitting element 20e, and one partial area 40e of a top surface of the light-guiding unit 4e is exposed by the second opening 31e. Hence, light beams Le generated by the at least one light-emitting element 20e are guided by the light-guiding unit 4e and are projected out from the at least one second opening 31e.

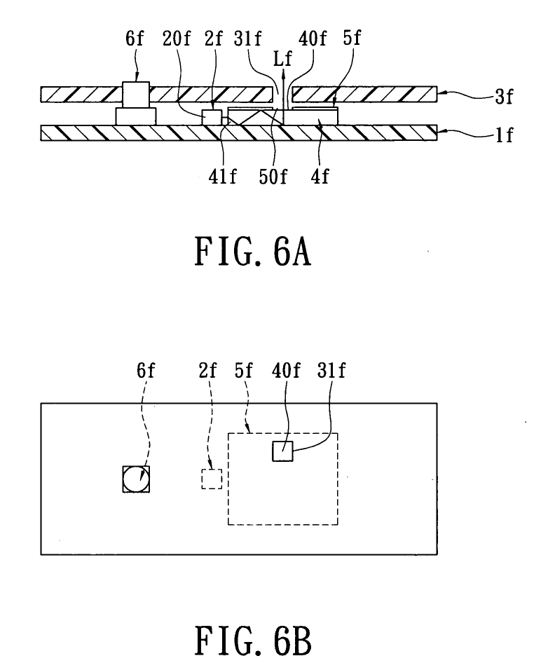

Referring to FIGS. 6A and 6B, the sixth embodiment of the present invention provides an image-capturing module for arbitrarily changing light-emitting position, including: a PCB unit 1f, a light-emitting unit 2f, an outer shell unit 3f, a light-guiding unit 4f and an image-capturing unit 6f. The difference between the sixth embodiment and the fourth and the fifth embodiments is that: in the sixth embodiment, the light-guiding unit 4f has a shading layer 5f disposed on a top surface thereof, and the shading layer 5f has at least one light-exiting hole 50f corresponding to the at least one second opening 31f. In addition, one partial area of one end portion 41f of the light-guiding unit 4f is close to the light-emitting element 20f, and one partial area 40f of a top surface of the light-guiding unit 4f is exposed by the second opening 31f and the light-exiting hole 50f. Hence, light beams Lf generated by the at least one light-emitting element 20f are guided by the light-guiding unit 4f and are projected out from the light-exiting hole 50f and the at least one second opening 31f.

In conclusion, the light-guiding unit is mated with the opening of the outer shell unit, so that the present invention can achieve signal indication effect without changing the position of the light-emitting element and the position of the opening of outer shell unit. In other words, the light-emitting position can be arbitrarily changed according to the design position of the opening of the outer shell unit.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A light-emitting module for arbitrarily changing light-emitting position, comprising:
a PCB unit;
a light-emitting unit having at least one light-emitting element electrically disposed on the PCB unit;
an outer shell unit disposed above the PCB unit and the light-emitting unit, wherein the outer shell unit has at least one opening; and
a light-guiding unit being close to the at least one light-emitting element, wherein one partial area of the light-guiding unit is exposed by the at least one opening, so that light beams generated by the at least one light-emitting element are guided by the light-guiding unit and are projected out from the at least one opening.

2. The light-emitting module according to claim 1, wherein the light-emitting element is an LED.

3. The light-emitting module according to claim 1, wherein the light-emitting element is a signal indicator lamp.

4. The light-emitting module according to claim 1, wherein the outer shell unit is a faceplate.

5. The light-emitting module according to claim 1, wherein the light-guiding unit is a light guide film, a light guide post, a light guide pipe, a light guide plate, a light guide ink, optic fibers or a prism.

6. The light-emitting module according to claim 1, wherein one end portion of the light-guiding unit is close to the light-emitting element, and another end portion of the light-guiding unit is close to the opening and is exposed by the opening.

7. The light-emitting module according to claim 1, wherein one partial area of one end portion of the light-guiding unit is close to the light-emitting element, and one partial area of a top surface of the light-guiding unit is exposed by the opening.

8. The light-emitting module according to claim 1, wherein the light-guiding unit has a shading layer disposed on its top surface, and the shading layer has at least one light-exiting hole corresponding to the at least one opening.

9. The light-emitting module according to claim 8, wherein one partial area of one end portion of the light-guiding unit is close to the light-emitting element, and one partial area of a top surface of the light-guiding unit is exposed by the opening and the light-exiting hole.

10. The light-emitting module according to claim 1, wherein the light-guiding unit is a plastic plate or a glass plate.

11. An image-capturing module for arbitrarily changing light-emitting position, comprising:
a PCB unit;
an image-capturing unit electrically disposed on the PCB unit;
a light-emitting unit disposed beside the image-capturing unit, wherein the
light-emitting unit has at least one light-emitting element electrically disposed on the PCB unit;
an outer shell unit disposed above the PCB unit and the light-emitting unit, wherein the outer shell unit has at least one first opening for exposing the image-capturing unit and at least one second opening beside the at least one first opening; and
a light-guiding unit being close to the at least one light-emitting element, wherein one partial area of the light-guiding unit is exposed by the at least one second opening, so that light beams generated by the at least one light-emitting element are guided by the light-guiding unit and are projected out from the at least one second opening.

12. The image-capturing module according to claim 11, wherein the light-emitting element is an LED.

13. The image-capturing module according to claim 11, wherein the light-emitting element is a signal indicator lamp.

14. The image-capturing module according to claim 11, wherein the outer shell unit is a faceplate.

15. The image-capturing module according to claim 11, wherein the light-guiding unit is a light guide film, a light guide post, a light guide pipe, a light guide plate, a light guide ink, optic fibers or a prism.

16. The image-capturing module according to claim 11, wherein one end portion of the light-guiding unit is close to the light-emitting element, and another end portion of the light-guiding unit is close to the second opening and is exposed by the second opening.

17. The image-capturing module according to claim 11, wherein one partial area of one end portion of the light-guiding unit is close to the light-emitting element, and one partial area of a top surface of the light-guiding unit is exposed by the second opening.

18. The image-capturing module according to claim 11, wherein the light-guiding unit has a shading layer disposed on its top surface, and the shading layer has at least one light-exiting hole corresponding to the at least one second opening.

19. The image-capturing module according to claim 18, wherein one partial area of one end portion of the light-guiding unit is close to the light-emitting element, and one partial area of a top surface of the light-guiding unit is exposed by the second opening and the light-exiting hole.

20. The image-capturing module according to claim 11, wherein the light-guiding unit is a plastic plate or a glass plate.
